(19) United States
(12) Patent Application Publication
(10) Pub. No.: US 2024/0322505 A1
(43) Pub. Date: Sep. 26, 2024

(54) ELECTRICAL CONNECTION DEVICE AND ELECTRICAL CONNECTION DEVICE ASSEMBLY

(71) Applicant: MOLEX, LLC, Lisle, IL (US)

(72) Inventors: Guo-Li Li, Shanghai (CN); Kui Wu, Shanghai (CN); Xue-Qing Zhang, Shanghai (CN)

(21) Appl. No.: 18/592,575

(22) Filed: Mar. 1, 2024

(30) Foreign Application Priority Data
Mar. 22, 2023 (CN) 202310293086.0

(51) Int. Cl. H01R 13/74; H01R 12/72

(52) U.S. Cl. CPC H01R 13/74; H01R 12/722

(57) ABSTRACT

An electrical connection device includes a panel and a connector. The panel is formed with an opened hole. The connector includes an insulative housing and a locking member. The insulative housing is configured to be capable of inserting into the opened hole of the panel and moving to an assembled position. The locking member has a protecting frame and a locking arm. The protecting frame has an inner frame body, an outer frame body and two side frame bodies which connects the inner frame body and the outer frame body. The locking arm has two end portions, an elastic arm portion and a lock protruding portion. The elastic arm portion is constructed as an elastic zone. The two end portions are connected to an inner side of the outer frame body so that the two side frame bodies are constructed as a deformable zone. When the lock protruding portion is squeezed by the panel, the elastic zone and the deformable zone all are capable of bending deformation. When the insulative housing is positioned in the assembled position, the lock protruding portion is locked to the panel.

### RELATED APPLICATION

The present application claims priority to Chinese patent application no. 202310293086.0 filed on Mar. 22, 2023, which is incorporated herein by reference in its entirety.

### TECHNICAL FIELD

The present disclosure relates to an electrical connection device, and particularly relates to an electrical connection device and an electrical connection device assembly which are used to be mounted to a panel and are capable of being locked to the panel.

### BACKGROUND

Chinese patent document CN1227785C discloses a system which is used to mount an electrical connector in a panel, and includes a panel, a connector, a latch arm and a protective shroud. The panel has an opening with a locating slot. The connector has a housing which may insert into the opening. The housing has a locating flange which is used to pass through the locating slot when the housing inserts into the opening. The housing further has a stop flange which is used to abut the panel when the locating flange clears the panel. The housing may move to a latched position in the opening. The latch arm projects from the housing and has a latch projection which is used to engage a side surface of the opening. When the housing is positioned in the latched position, the latch arm engages with a latch surface of the panel. The protective shroud is disposed about the latch arm to protect the latch arm against breakage. The protective shroud has a triangular opening. The latch arm is V-shaped and is provided to the triangular opening. Because the latch arm is directly connected to a side of the housing, an elasticity which the latch arm has is limited and is not good.

Chinese patent document CN1822443B discloses an electrical connector for being mounted on a panel. The electrical connector includes a housing. The housing has a forward mating end, a first side and a second side. When the housing moves toward an insertion position, the housing inserts into an opening of a panel. When the housing moves toward a latched position, the housing is movable in the opening. The housing has a latch member connected to the first side surface. A serpentine latch beam connects a first end and a second end of the latch member. A latching element is disposed on a front surface of the serpentine latch beam. When the housing is in the latched position, the latching element engages with an inner edge of the opening of the panel to maintain the housing in the latched position. The serpentine shape of the serpentine latch beam provides an increased length for the latch beam, the increased length gives the serpentine latch beam for sufficient flexibility. Because the electrical connector does not have a protective shroud mentioned in the previous patent document, the serpentine latch beam is prone to be damaged due to exposure of a periphery of the serpentine latch beam to the outside, the serpentine latch beam also has no way to utilize the protective shroud structure to improve elasticity of the serpentine latch beam. Accordingly, an elasticity which the serpentine latch beam has also is limited and is not good.

### SUMMARY

Therefore, one of objects of the present disclosure is to provide an electrical connection device which can overcome at least one deficiency of prior art.

Accordingly, an electrical connection device of the present disclosure comprises a panel and a connector. The panel is formed with an opened hole. The connector comprises an insulative housing and a locking member. The insulative housing is configured to be capable of inserting into the opened hole of the panel and moving in the opened hole to an assembled position. The locking member has a protecting frame and a locking arm positioned in the protecting frame. The protecting frame has an inner frame body which is connected to the insulative housing, an outer frame body, and two side frame bodies which connect the inner frame body and the outer frame body. The locking arm has two end portions, an elastic arm portion which is connected between the two the end portions, and a lock protruding portion which is connected to the elastic arm portion. The clastic arm portion is constructed as an elastic zone which is bendable. The two end portions are connected to an inner side of the outer frame body so that the two side frame bodies of the protecting frame are constructed as a deformable zone which is bendable. When the lock protruding portion is squeezed by the panel, the elastic zone and the deformable zone all are capable of bending deformation. When the insulative housing is positioned in the assembled position, the lock protruding portion inserts into the opened hole and is locked to the panel.

In some embodiments, a thickness of the clastic arm portion is less than a thickness of each end portion.

In some embodiments, a width of the clastic arm portion is less than a width of each end portion.

In some embodiments, a thickness of each side frame body tapers from the inner frame body toward the outer frame body.

In some embodiments, the elastic arm portion of the locking arm is in form of M-shape and has a pointed convex segment which convexly extends toward the outer frame body, the lock protruding portion protrudes from the pointed convex segment.

In some embodiments, the insulative housing has a mating portion, the connector further comprises a plurality of terminals provided to the mating portion.

In some embodiments, the insulative housing is configured to be capable of moving relative to the panel along a first direction to an inserting position where the insulative housing inserts into the opened hole, and is capable of moving from the inserting position to the assembled position along a second direction perpendicular to the first direction.

In some embodiments, the panel comprises a first panel surface and a second panel surface which are opposite to each other, the opened hole extends between the first panel surface and the second panel surface and has an aligning hole portion, the insulative housing is capable of inserting into the opened hole from the first panel surface along the first direction, the insulative housing has an alignment protruding block and an abutment protruding block which is spaced apart from the alignment protruding block along the first direction, when the insulative housing is in the inserting position, the alignment protruding block passes through the aligning hole portion and extends out of the second panel surface, the abutment protruding block abuts the first panel surface, when the insulative housing is in the assembled position, the alignment protruding block stops the second panel surface, the abutment protruding block abuts the first panel surface.

In some embodiments, the connector is a receptacle connector.

In some embodiments, the connector is a plug connector.

Accordingly, an electrical connection device of the present disclosure comprises a circuit board; and a plug connector. The plug connector is erectly provided to the circuit board and comprises an insulative housing, a plurality of terminals provided to the insulative housing, and a spacing plate. Each terminal has a tail segment electrically connected to the circuit board. The spacing plate has a retaining segment which is retained in the insulative housing, an extending suspending segment which extends out of the insulative housing, and a protrusion which extends from the extending suspending segment toward the circuit board. The extending suspending segment and the circuit board are therebetween formed with a gap. The extending suspend segment is formed with a plurality of penetrating holes which respectively allow the plurality of the tail segments of the plurality of the terminals to insert therein.

In some embodiments, the protrusion is positioned in the middle of the plurality of the penetrating holes.

In some embodiments, the plurality of the penetrating holes are arranged as columns along a first direction and are arranged as rows along a second direction perpendicular to the first direction, the number of the columns and the number of the rows each are even, the protrusion is positioned in the middle of the columns in the first direction and is positioned in the middle of the rows in the second direction.

In some embodiments, the protrusion is adjacent to the circuit board and does not contact the circuit board.

In some embodiments, the protrusion abuts the circuit board.

In some embodiments, the insulative housing has a bottom portion and at least one positioning post which extends downwardly from the bottom portion, the retaining segment is formed with at least one positioning hole which interference fits with the positioning post.

In some embodiments, the insulative housing has two positioning posts which are spaced apart from each other, the retaining segment is formed with two positioning holes which respectively interference fit with the two positioning posts.

In some embodiments, the insulative housing has a bottom portion and two wall portions which extend downwardly from the bottom portion and are respectively adjacent to two opposite sides of the bottom portion, each wall portion is formed with a snapping groove, the retaining segment has two side edge portions which respectively snap to the two snapping grooves of the two wall portions.

Another object of the present disclosure is to provide an electrical connection device assembly which can overcome at least one deficiency of prior art.

Accordingly, an electrical connection device assembly of the present disclosure comprises the aforementioned electrical connection device and a plug electrical connection device. The electrical connection device is a receptacle electrical connection device, the connector is a receptacle connector. The plug electrical connection device is used to mate with the receptacle connector of the receptacle electrical connection device.

Accordingly, an electrical connection device assembly of the present disclosure comprises: the aforementioned electrical connection device, the electrical connection device is a receptacle electrical connection device, the connector is a receptacle connector; and the aforementioned electrical connection device, the electrical connection device is a plug electrical connection device, the plug connector is used to mate with the receptacle connector.

Accordingly, an electrical connection device assembly of the present disclosure comprises: the aforementioned electrical connection device, the electrical connection device is a receptacle electrical connection device, the connector is a receptacle connector; and the aforementioned electrical connection device, the electrical connection device is a plug electrical connection device, the connector is a plug connector which is used to mate with the receptacle connector.

The present disclosure at least has the following effect: by that the protecting frame is a frame which encircles the outer periphery of the locking arm, the protecting frame can function as protecting the outer periphery of the locking arm, so as to avoid the locking arm being subjected to improper external force hit and being damaged. By that the elastic arm portion is connected between the two end portions to construct the elastic zone which is bendable, and the two end portions are connected to the inner side of the outer frame body so that the two side frame bodies are constructed as the deformable zone which is bendable, the locking member has better elasticity. Therefore, velocity and smoothness of deformation of the locking member can be promoted when the lock protruding portion is squeezed by the panel or is separated from the panel and is not squeezed by the panel. Moreover, by that the protrusion extends from the extending suspending segment toward the circuit board, the extending suspending segment will not contact the circuit board and even will not approach the circuit board. Therefore, it can avoid solder wicking phenomenon occurring and in turn resulting in short circuit between the plurality of terminals when the plurality of tail segments are soldered to the plurality of soldering holes.

### BRIEF DESCRIPTION OF THE DRAWINGS

Other features and effects of the present disclosure will be apparent from embodiments with reference to the drawings, in which:

FIG. 1 is a perspective exploded view of a first embodiment of an electrical connection device assembly of the present disclosure illustrating an assembling relationship between a receptacle electrical connection device and a plug electrical connection device;

FIG. 2 is a perspective exploded view of the first embodiment illustrating an assembling relationship among a panel, a connector, a circuit board and a plug connector;

FIG. 3 is a perspective exploded view of the first embodiment viewed from another angle;

FIG. 4 is a front view of an insulative housing and a locking member of the first embodiment;

FIG. 5 is a cross sectional view taken along a line V-V of FIG. 4;

FIG. 6 is an assembling schematic view of the receptacle electrical connection device of the first embodiment illustrating the insulative housing in an inserting position;

FIG. 7 is a cross sectional view taken along a line VII-VII of FIG. 6;

FIG. 8 is an assembling schematic view of the receptacle electrical connection device of the first embodiment illustrating the insulative housing in an assembled position;

FIG. 9 is a cross sectional view taken along a line IX-IX of FIG. 8;

FIG. 10 is a front view of the plug electrical connection device of the first embodiment;

FIG. 11 is a perspective exploded view of a second embodiment of the electrical connection device assembly of the present disclosure;

FIG. 12 is a perspective exploded view of the second embodiment;

FIG. 13 is a perspective exploded view of the second embodiment viewed from another angle;

FIG. 14 is a front view of the insulative housing and the locking member of the receptacle electrical connection device of the second embodiment;

FIG. 15 is a cross sectional view taken along a line XV-XV of FIG. 14;

FIG. 16 is a cross sectional view of the receptacle electrical connection device of the second embodiment;

FIG. 17 is a cross sectional view of the receptacle electrical connection device of the second embodiment;

FIG. 18 is a rear view of an insulative housing and a locking member of the plug electrical connection device of the second embodiment;

FIG. 19 is a cross sectional view taken along a line XIX-XIX of FIG. 18;

FIG. 20 is a cross sectional view of the plug electrical connection device of the second embodiment; and

FIG. 21 is a cross sectional view of the plug electrical connection device of the second embodiment.

### DETAILED DESCRIPTION

Before the present disclosure is described in detail, it is noted that the similar elements are indicated by the same reference numerals in the following description.

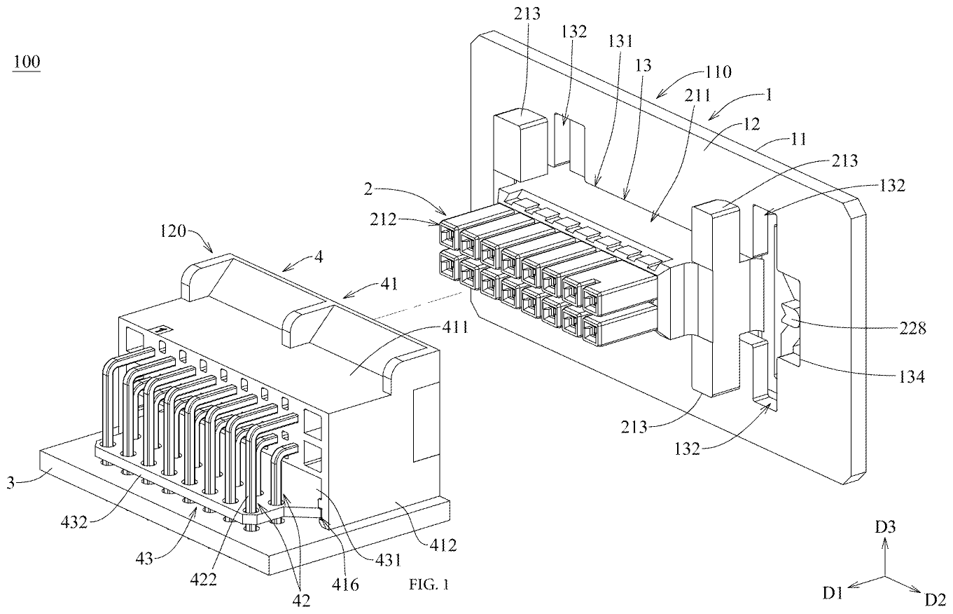

Referring to FIG. 1, a first embodiment of an electrical connection device assembly 100 of the present disclosure includes a receptacle electrical connection device 110 and a plug electrical connection device 120 which is used to mate with the receptacle electrical connection device 110.

For sake of convenience of the later description, in the electrical connection device assembly 100, a first direction D1, a second direction D2 perpendicular to the first direction D1 and a third direction D3 perpendicular to the first direction D1 and the second direction D2 are defined. In the first embodiment, the first direction D1 takes a front-rear direction as example, in FIG. 1, a direction to which an arrow points is front and a direction opposite to front is rear. The second direction D2 takes a left-right direction as example, in FIG. 1, a direction to which an arrow points is left and a direction opposite to left is right. The third direction D3 takes an up-down direction as example, in FIG. 1, a direction to which an arrow points is up and a direction opposite to up is down.

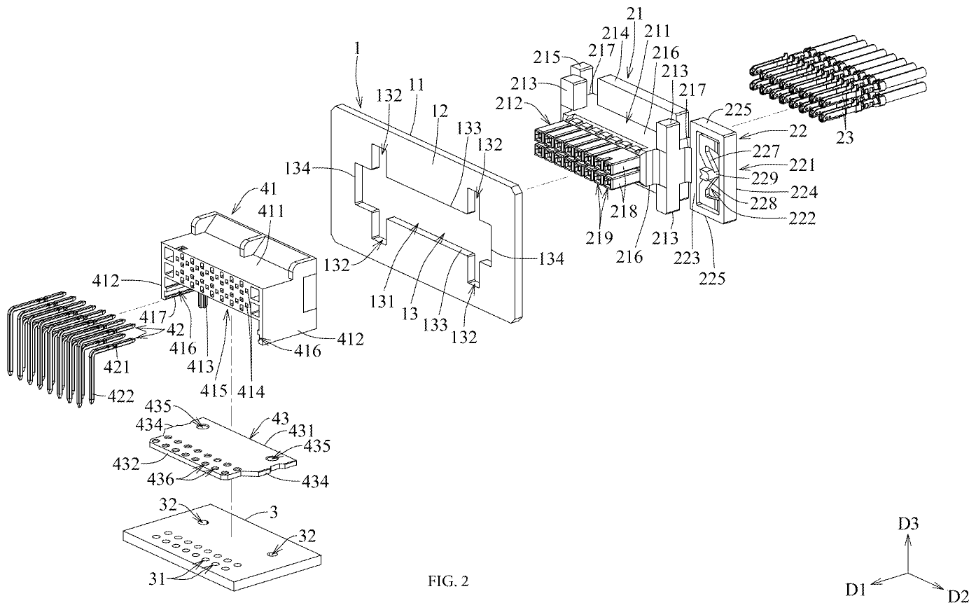

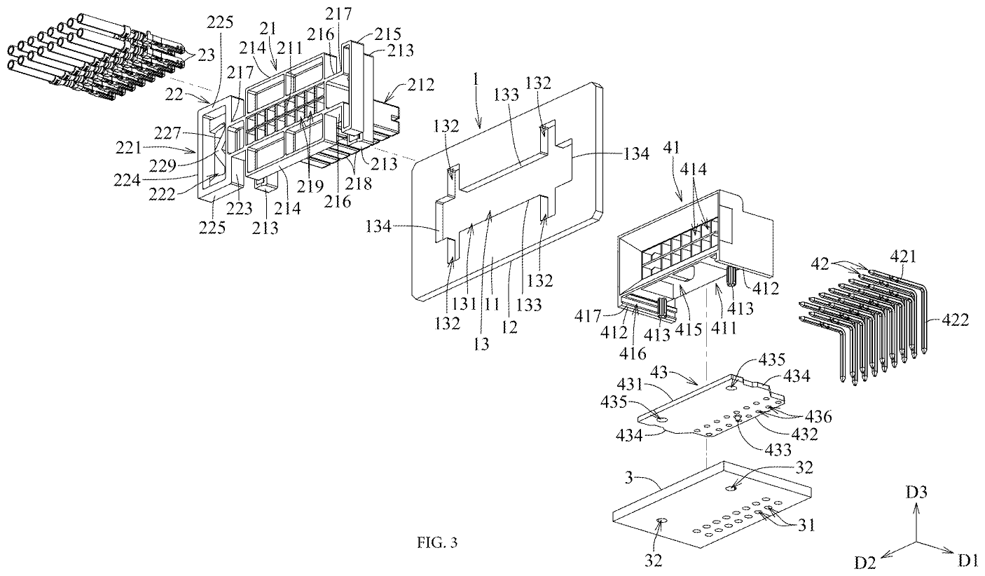

Referring to FIG. 1, FIG. 2 and FIG. 3, the receptacle electrical connection device 110 includes a panel 1 and a connector 2. The panel 1 includes a first panel surface 11 which is toward the rear and a second panel surface 12 which is toward the front and is opposite to the first panel surface 11. The panel 1 is formed with an opened hole 13 which extends between the first panel surface 11 and the second panel surface 12. The opened hole 13 has a long hole portion 131 and two pairs of aligning hole portions 132 communicated with the long hole portion 131. A length direction of the long hole portion 131 extends along the second direction D2. The long hole portion 131 is defined together by two long inner sides 133 of the panel 1 which are spaced apart from each other along the third direction D3 and two short inner sides 134 of the panel 1 which are spaced apart from each other along the second direction D2. Each pair of aligning hole portions 132 respectively extend upwardly and downwardly from two long inner sides 133 and are adjacent to the corresponding short inner side 134.

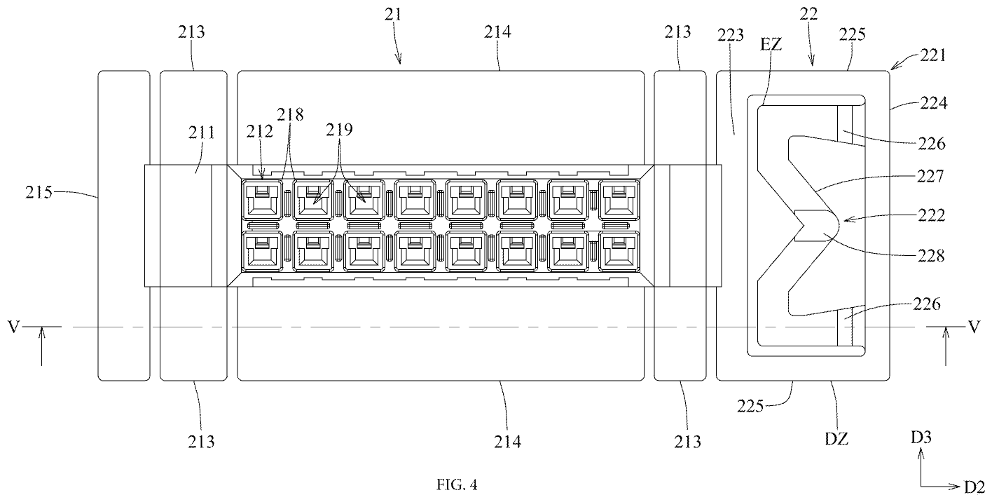

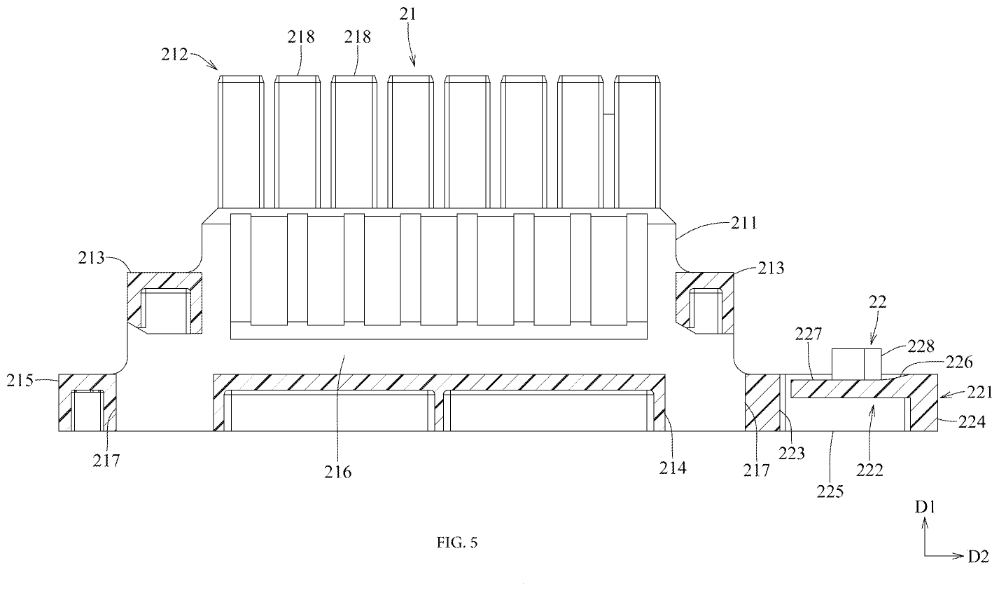

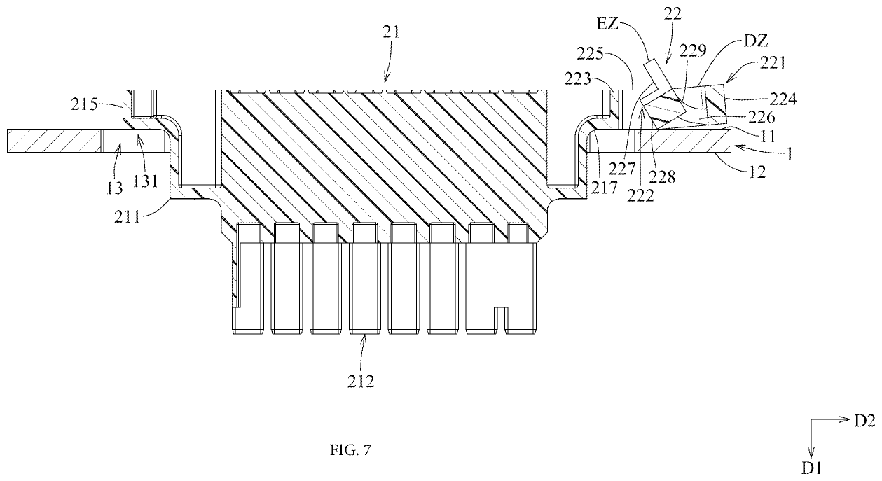

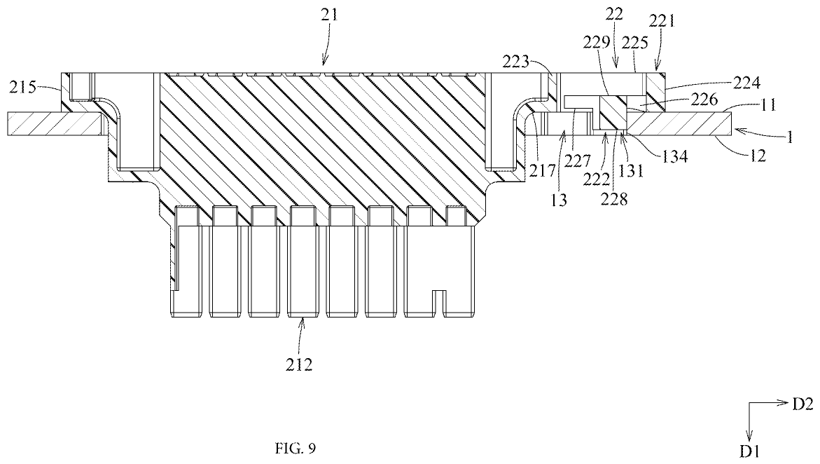

Referring to FIG. 2, FIG. 3, FIG. 4 and FIG. 5, the connector 2 is a receptacle connector and includes an insulative housing 21, a locking member 22 and a plurality of terminals 23. The insulative housing 21 is configured to be capable of moving relative to the panel 1 along the first direction D1 to an inserting position (as shown in FIG. 7) where the insulative housing 21 inserts into the opened hole 13 from the first panel surface 11 and be capable of moving from the inserting position to an assembled position (as shown in FIG. 9) along the second direction D2. The insulative housing 21 has a body portion 211, a mating portion 212, two pairs of alignment protruding blocks 213, a pair of first abutment protruding blocks 214, and a second abutment protruding block 215. The body portion 211 is in form of elongated shell shape and has two long sides 216 which are spaced apart from each other along the third direction D3 and two short sides 217 which are spaced apart from each other along the second direction D2. The body portion 211 is used to insert into the long hole portion 131 of the opened hole 13 and is capable of partially extending out of the second panel surface 12. The body portion 211 is capable of moving in the long hole portion 131 along the second direction D2.

The mating portion 212 extends forwardly from the body portion 211 and has a plurality of mating posts 218 which are arranged and are spaced apart from each other. The plurality of mating posts 218 and the body portion 211 together define a plurality of terminal slots 219 which are arranged, are spaced apart from each other and are used to respectively allow the plurality of terminals 23 to be received therein. The mating portion 212 is used to insert into the long hole portion 131 of the opened hole 13 and is capable of passing through the long hole portion 131 and extending out of the second panel surface 12.

Each pair of alignment protruding blocks 213 respectively extend upwardly and downwardly from the two long sides 216 of the body portion 211 and are adjacent to the corresponding short side 217 and the mating portion 212. Each alignment protruding block 213 is used to insert into the corresponding aligning hole portion 132 of the opened hole 13. By an alignment mechanism provided by cooperation of the alignment protruding block 213 and the corresponding aligning hole portion 132, the insulative housing 21 indeed can be guided to move to the inserting position. When the insulative housing 21 is in the inserting position, each alignment protruding block 213 passes through the corresponding aligning hole portion 132 and extends out of the second panel surface 12. When the insulative housing 21 is in the assembled position, each alignment protruding block 213 stops the second panel surface 12.

The pair of first abutment protruding blocks 214 respectively extend upwardly and downwardly from the two long sides 216 of the body portion 211. Each first abutment protruding block 214 is away from the mating portion 212, is positioned behind the corresponding alignment protruding block 213 along the first direction D1, and is spaced apart from the corresponding alignment protruding block 213 by a certain distance. Each first abutment protruding block 214 is used to abut the first panel surface 11 of the panel 1 so as to limit a depth that the body portion 211 inserts into the long hole portion 131. The second abutment protruding block 215 is connected to one of the two short sides 217 of the body portion 211, is used to abut the first panel surface 11 so as to limit the depth that the body portion 211 inserts into the long hole portion 131. When the insulative housing 21 is in the inserting position or the assembled position, each first abutment protruding block 214 and the second abutment protruding block 215 all abut the first panel surface 11.

The locking member 22 has a protecting frame 221 and a locking arm 222 positioned in the protecting frame 221. The protecting frame 221 has an inner frame body 223 which is connected to the other of the two short sides 217 of the insulative housing 21, an outer frame body 224 which is spaced apart from the inner frame body 223 along the second direction D2 and is positioned at an outer side of the inner frame body 223, and two side frame bodies 225 which are connected between the inner frame body 223 and the outer frame body 224 and are spaced apart from each other along the third direction D3. In the first embodiment, that the second abutment protruding block 215 is connected to the short side 217 which is positioned at the right is taken as example, and that the inner frame body 223 is connected to the short side 217 which is positioned at the left is taken as example.

The locking arm 222 has two end portions 226, an elastic arm portion 227 which is connected between the two end portions 226, and a lock protruding portion 228 which is connected to a front-end surface of the elastic arm portion 227. The elastic arm portion 227 is constructed as an elastic zone EZ which is bendable. The two end portions 226 are connected to an inner side of the outer frame body 224, so as to make the two side frame bodies 225 of the protecting frame 221 constructed as a deformable zone DZ which is bendable. That the two end portions 226 of the first embodiment are integrally connected to the outer frame body 224 is taken as example. The lock protruding portion 228 protrudes from a front-end surface of the protecting frame 221, is used to contact the first panel surface 11 of the panel 1, and is used to insert into the long hole portion 131 of the opened hole 13 so as to be locked to the corresponding short inner side 134. When the lock protruding portion 228 is squeezed by the first panel surface 11 of the panel 1, the clastic zone EZ and the deformable zone DZ all are capable of bending deformation. When the insulative housing 21 is positioned in the assembled position, the lock protruding portion 228 inserts into the long hole portion 131 so as to be locked to the corresponding short inner side 134.

In the first embodiment, the elastic arm portion 227 of the locking arm 222 is in form of M-shape, the elastic arm portion 227 has a length interposed between the two end portions 226. Therefore, the elastic arm portion 227 can have a longer length and a better elasticity under restriction of a limited space of the protecting frame 221. The elastic arm portion 227 has a pointed convex segment 229 which convexly extends toward the outer frame body 224, the lock protruding portion 228 protrudes from a front-end surface of the pointed convex segment 229. Therefore, when the lock protruding portion 228 is squeezed by the first panel surface 11 to be subjected to a force, the lock protruding portion 228 is capable of uniformly dispersing the force upwardly and downwardly to the elastic arm portion 227. A thickness of the elastic arm portion 227 taken along the first direction D1 is less than a thickness of each end portion 226 taken along the first direction D1, a width of the elastic arm portion 227 is less than a width of each end portion 226. Therefore, the elasticity of the elastic arm portion 227 can be further increased, and a connecting strength between each end portion 226 and the inner side of the outer frame body 224 can be increased.

Each terminal 23 is a female terminal which is received in the corresponding terminal slot 219.

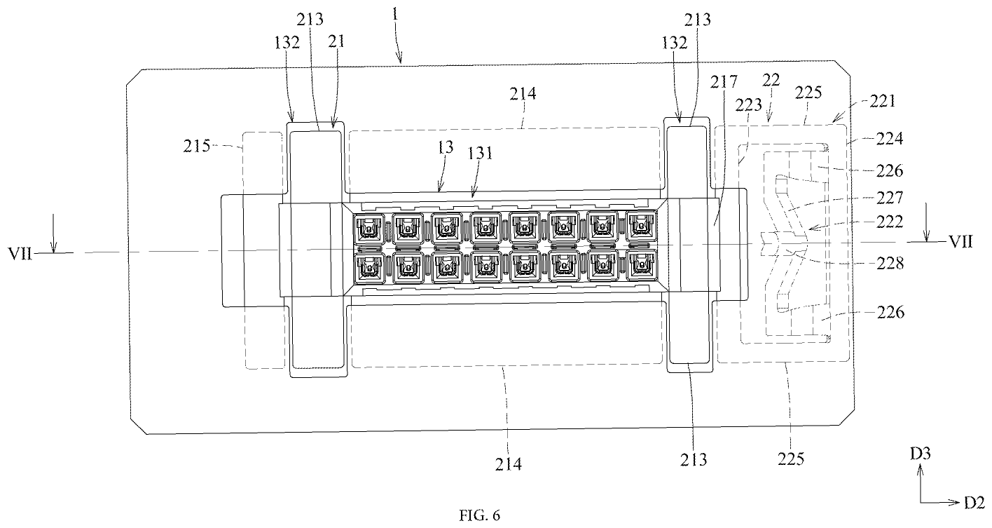

Referring to FIG. 2, FIG. 6 and FIG. 7, when the insulative housing 21 is to be assembled to the panel 1, firstly, the mating portion 212 is aligned with the long hole portion 131 of the opened hole 13 and each alignment protruding block 213 is aligned with the corresponding aligning hole portion 132 of the opened hole 13. Next, the insulative housing 21 is moved forwardly toward the first panel surface 11 of the panel 1 along the first direction D1. The mating portion 212 firstly inserts into the long hole portion 131 and then passes through the long hole portion 131 and extends out of the second panel surface 12. Subsequently, the body portion 211 inserts into the long hole portion 131 and partially extend out of the second panel surface 12. Each alignment protruding block 213 inserts into the corresponding aligning hole portion 132 of the opened hole 13 and then passes through the corresponding aligning hole portion 132 and extends out of the second panel surface 12. Then, the lock protruding portion 228 of the locking member 22 will contact the first panel surface 11 of the panel 1 and is squeezed by the first panel surface 11. A squeezing force applied to the lock protruding portion 228 by the first panel surface 11 will make the lock protruding portion 228 bring the clastic arm portion 227 to rotate relative to the two end portions 226, which makes the elastic arm portion 227 bent and deformed and accumulate a restoring elastic force. The squeezing force will be further transferred to the two side frame bodies 225 via the two end portions 226 and the outer frame body 224, which makes the two side frame bodies 225 bent and deformed and accumulate a restoring elastic force.

When the two first abutment protruding blocks 214 and the second abutment protruding block 215 abut the first panel surface 11 of the panel 1, the insulative housing 21 cannot further move forwardly and thus is positioned in the inserting position.

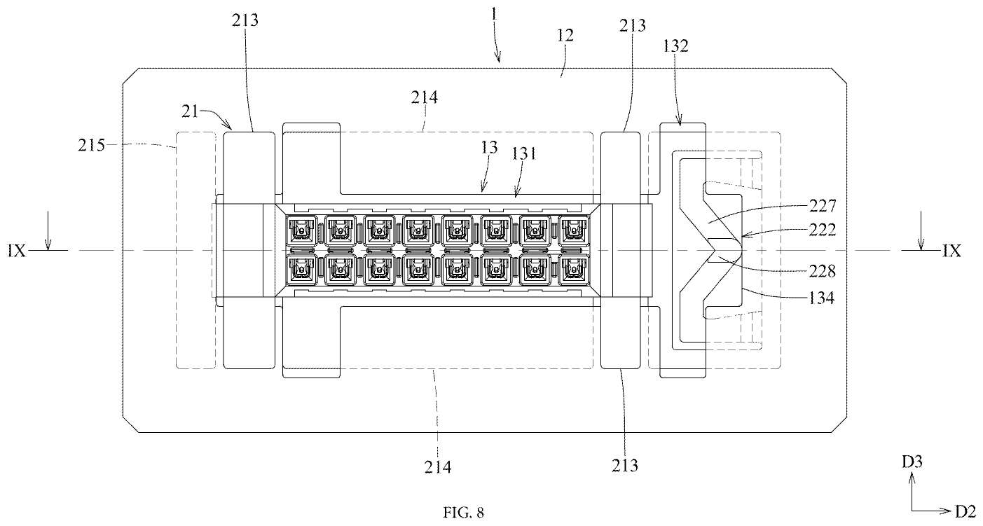

Referring to FIG. 1, FIG. 8 and FIG. 9, the insulative housing 21 is pushed rightwardly along the second direction D2, so that the insulative housing 21 is moved rightwardly from the inserting position. In a process that the insulative housing 21 is moved rightwardly, each alignment protruding block 213 leaves the corresponding aligning hole portion 132 and moves to in front of the second panel surface 12, but the lock protruding portion 228 will move rightwardly relative to the first panel surface 11 in a state that the lock protruding portion 228 abuts the first panel surface 11 with applying an clastic force to the first panel surface 11.

When the insulative housing 21 moves to the assembled position as shown in FIG. 9, the restoring clastic force accumulated by the elastic arm portion 227 brings the lock protruding portion 228 to rotate and restore, and the restoring clastic force accumulated by the two side frame bodies 225 brings the outer frame body 224 and the locking arm 222 to rotate and restore, so the lock protruding portion 228 is capable of automatically inserting into the long hole portion 131 and being locked to the corresponding short inner side 134. By that the lock protruding portion 228 is locked to the corresponding short inner side 134, it can prevent the insulative housing 21 from shaking along the second direction D2. By that the two pairs of alignment protruding blocks 213 stop the second panel surface 12 and the two first abutment protruding blocks 214 and the second abutment protruding block 215 abut the first panel surface 11, it can prevent the insulative housing 21 from shaking along the first direction D1. Therefore, the insulative housing 21 can be firmly positioned in the assembled position.

By that the protecting frame 221 is a frame which encircles an outer periphery of the locking arm 222, the protecting frame 221 can function as protecting the outer periphery of the locking arm 222, so as to avoid the locking arm 222 being subjected to improper external force hit and being damaged. Moreover, by that the elastic arm portion 227 is connected between the two end portions 226 to construct the clastic zone EZ which is bendable, and the two end portions 226 are connected to the inner side of the outer frame body 224 so that the two side frame bodies 225 are constructed as the deformable zone DZ which is bendable, the locking member 22 has better elasticity. Therefore, velocity and smoothness of deformation of the locking member 22 can be promoted when the lock protruding portion 228 is squeezed by the panel 1 or the lock protruding portion 228 is separated from the panel 1 and is not squeezed by the panel 1.

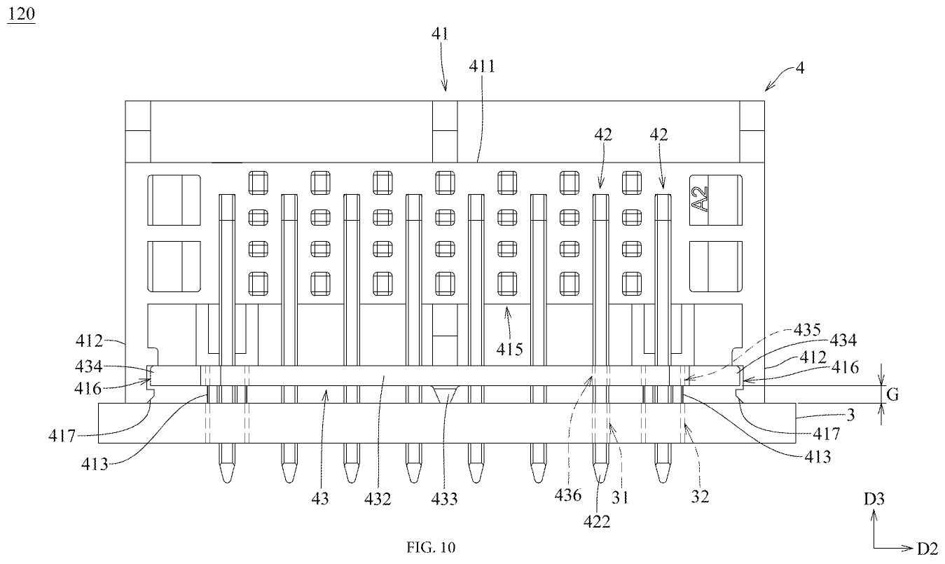

Referring to FIG. 1, FIG. 2, FIG. 3 and FIG. 10, the plug electrical connection device 120 includes a circuit board 3 and a plug connector 4. The circuit board 3 is formed with a plurality of soldering holes 31 which are arranged and are spaced apart from each other and two positioning holes 32 which are arranged and are spaced apart from each other along the second direction D2 and are positioned behind the plurality of soldering holes 31. The plug connector 4 takes a right-angle type of connector as example. The plug connector 4 is erectly provided on the circuit board 3 and includes an insulative housing 41, a plurality of terminals 42 and a spacing plate 43. The insulative housing 41 has a body portion 411, two wall portions 412 and two positioning posts 413. The body portion 411 is formed with a plurality of terminal slots 414 which are arranged and are spaced apart from each other, the plurality of terminal slots 414 are used to respectively allow the plurality of terminals 42 to be received therein and are used to respectively allow the plurality of mating posts 218 to insert therein. The body portion 411 has a bottom portion 415. The two wall portions 412 extend downwardly from the bottom portion 415 of the body portion 411, are respectively adjacent to two opposite sides of the bottom portion 415 and are space apart from each other along the second direction D2. An inner side of each wall portion 412 is formed with a snapping groove 416 which extends along the first direction D1. Each wall portion 412 has a guiding surface 417 which is toward the down. The guiding surface 417 is an oblique surface which obliquely extends inwardly from down to up. The two positioning posts 413 extends downwardly from the bottom portion 415 of the body portion 411, are positioned between the two wall portions 412 and are space apart from each other along the second direction D2. The two positioning posts 413 are used to respectively insert into the two positioning holes 32 of the circuit board 3.

Each terminal 42 is a male terminal and has a mating segment 421 and a tail segment 422. The mating segment 421 is partially received in the corresponding terminal slot 414 and partially extends out of a front end of the body portion 411. The mating segment 421 is used to insert into the corresponding terminal 23 and is electrically connected with the corresponding terminal 23. The tail segment 422 extends downwardly from a front end of the mating segment 421. The tail segment 422 is used to insert into the corresponding soldering hole 31 and is soldered to the corresponding soldering hole 31 by a solder, so that the tail segment 422 can be electrically connected to the circuit board 3.

The spacing plate 43 has a retaining segment 431 which is used to be retained in the insulative housing 41, an extending suspending segment 432 which is connected to a front end of the retaining segment 431 and extends out of the insulative housing 41, and a protrusion 433 which extends from the extending suspending segment 432 toward the circuit board 3. The retaining segment 431 has two side edge portions 434 which are spaced apart from each other along the second direction D2. The two side edge portions 434 are used to be respectively snapped to the two snapping grooves 416 of the two wall portions 412. The retaining segment 431 is formed with two positioning holes 435 which are spaced apart from each other along the second direction D2, the two positioning holes 435 are used to respectively allow the two positioning posts 413 to insert therein and are capable of respectively interference fitting with the two positioning posts 413.

The extending suspending segment 432 is formed with a plurality of penetrating holes 436, the plurality of penetrating holes 436 are used to respectively allow the plurality of tail segments 422 of the plurality of terminals 42 to insert therein. The protrusion 433 is positioned in the middle of the plurality of penetrating holes 436 and is used to at least be adjacent to a top surface of the circuit board 3. In the first embodiment, the plurality of penetrating holes 436 are arranged as columns along the first direction D1 and are arranged as rows along the second direction D2, such that, as an example, there are an even number of the columns and number of the rows. Here, that the columns are two columns is taken as example, but is not limited thereto, that the rows are eight rows is taken as example, but is not limited thereto. The protrusion 433 is positioned in the middle of the columns in the first direction D1 and is positioned in the middle of the rows in the second direction D2. The protrusion 433 is used to abut the top surface of the circuit board 3.

When the plug electrical connection device 120 is to be assembled, firstly, the plurality of mating segments 421 of the plurality of terminals 42 respectively insert into the plurality of terminal slots 414. Next, the two side edge portions 434 of the retaining segment 431 of the spacing plate 43 are respectively aligned with below the guiding surfaces 417. The spacing plate 43 is moved upwardly along the third direction D3 toward the insulative housing 41, to make the two positioning post 413 respectively insert into the two positioning holes 435 and extend out of a bottom surface of the spacing plate 43, and make the plurality of tail segments 422 of the plurality of terminals 42 respectively insert into the plurality of penetrating holes 436 and extend out of the bottom surface of the spacing plate 43.

When two side edge portions 434 respectively contact and squeeze the guiding surfaces 417, the two side edge portions 434 will make the two wall portions 412 splay outwardly and make the two wall portions 412 bent and deformed and accumulate a restoring elastic force. When the two side edge portions 434 respectively pass over the guiding surfaces 417 and are respectively aligned with the two snapping grooves 416, the restoring elastic force accumulated by the two wall portions 412 brings the two snapping grooves 416 to restore, so that the two side edge portions 434 respectively snap to the two snapping grooves 416. By that the two positioning holes 435 respectively interference fit with the two positioning posts 413, it can prevent the spacing plate 43 from shaking in a plane which is constituted together by the first direction D1 and the second direction D2, it can further prevent the spacing plate 43 from shaking along the third direction D3. By that the two side edge portions 434 of the retaining segment 431 respectively snap to the two snapping grooves 416, it can prevent the spacing plate 43 from shaking along the second direction D2 and the third direction D3. Therefore, the retaining segment 431 of the spacing plate 43 can be firmly retained in the insulative housing 41 and can function as an effect to prevent the plurality of terminals 42 from moving relative to the insulative housing 41, so as to avoid the plurality of mating segments 421 respectively detaching from the plurality of terminal slots 414.

Finally, the insulative housing 41 is moved downwardly along the third direction D3 toward the circuit board 3, to make the two wall portions 412 abut the top surface of the circuit board 3, the two positioning posts 413 respectively insert into the two positioning holes 435, and the plurality of tail segments 422 of the plurality of terminals 42 respectively insert into the plurality of soldering holes 31, that is, the assembling of the plug electrical connection device 120 is completed. At this time, a bottom surface of the extending suspending segment 432 of the spacing plate 43 and the top surface of the circuit board 3 is therebetween formed with a gap G, and the protrusion 433 abuts the top surface of the circuit board 3.

By the protrusion 433 extends from the extending suspending segment 432 toward the circuit board 3 and can function to abut the top surface of the circuit board 3, so that the extending suspending segment 432 will not contact the circuit board 3. More specifically, by that the protrusion 433 abuts the top surface of the circuit board 3, it can assure that the bottom surface of the extending suspending segment 432 exposing out of a front end of the insulative housing 41 of and the top surface of the circuit board 3 are therebetween always maintained with the gap G, so that the extending suspending segment 432 will not approach the circuit board 3. Therefore, it can avoid solder wicking phenomenon occurring and in turn resulting in short circuit between the plurality of terminals 42 when the plurality of tail segments 422 are soldered to the plurality of soldering holes 31. Moreover, by that the protrusion 433 is positioned in the middle of the columns of penetrating holes 436 in the first direction D1 and is positioned in the middle of the rows of penetrating holes 436 in the second direction D2, the protrusion 433 is capable of functioning to support the extending suspending segment 432 in the middle of the plurality of penetrating holes 436 so as to avoid the extending suspending segment 432 generating skew.

It is noted that, the electrical connection device assembly 100 of the first embodiment also may have the following implementing manners as desired.

One implement manner is the number of the aligning hole portion 132 of the panel 1 and the number of the alignment protruding block 213 of the insulative housing 21 each are one.

Another implement manner is the number of the first abutment protruding block 214 of the insulative housing 21 is one and the second abutment protruding block 215 is omitted.

Still another implement manner is, the insulative housing 21 only has the second abutment protruding block 215 and the first abutment protruding blocks 214 omitted.

Yet another implement manner is, the number of the positioning post 413 of the insulative housing 41 and the number of the positioning hole 435 of the spacing plate 43 each are one.

Further implement manner is, the protrusion 433 is adjacent to the top surface of the circuit board 3 and does not contact the top surface of the circuit board 3.

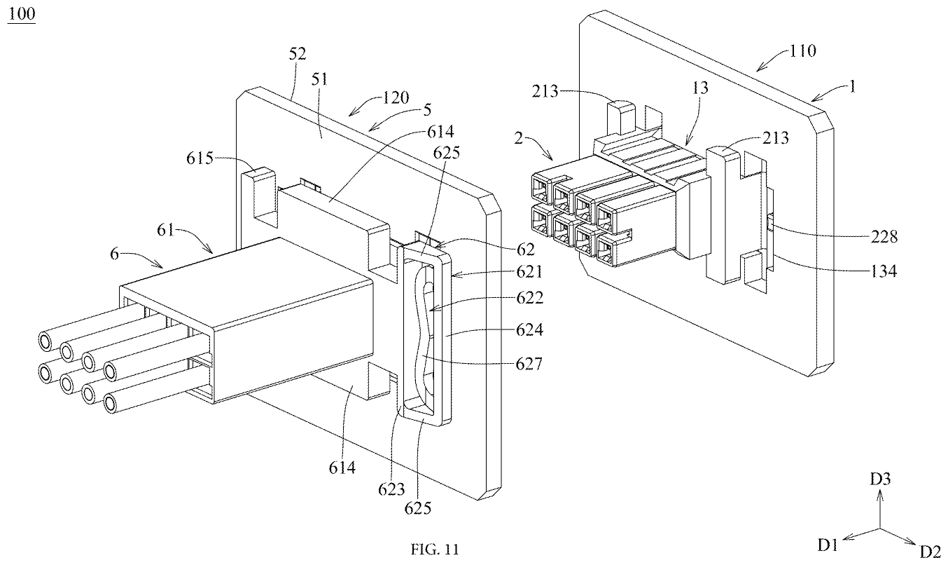

Referring to FIG. 11, a second embodiment of the electrical connection device assembly 100 of the present disclosure is the same as the first embodiment in entire structure, difference lies in the receptacle electrical connection device 110 and the plug electrical connection device 120.

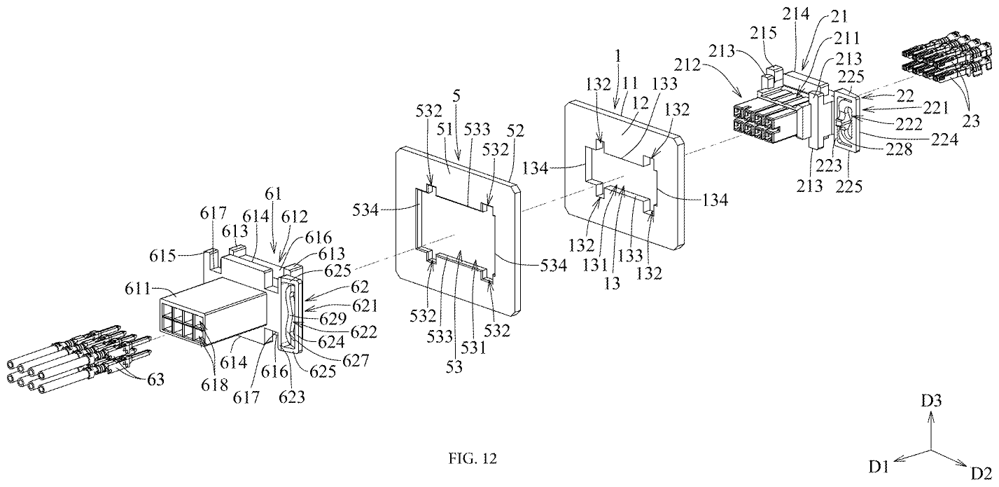

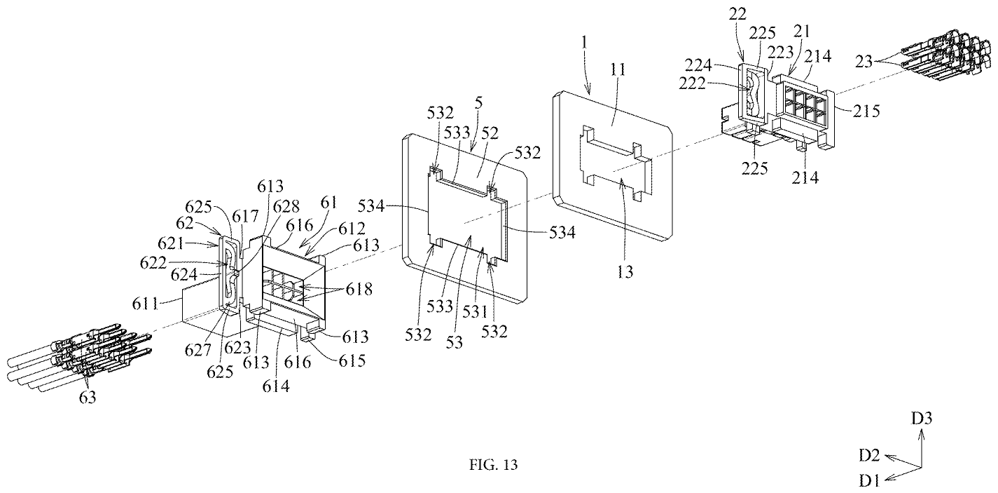

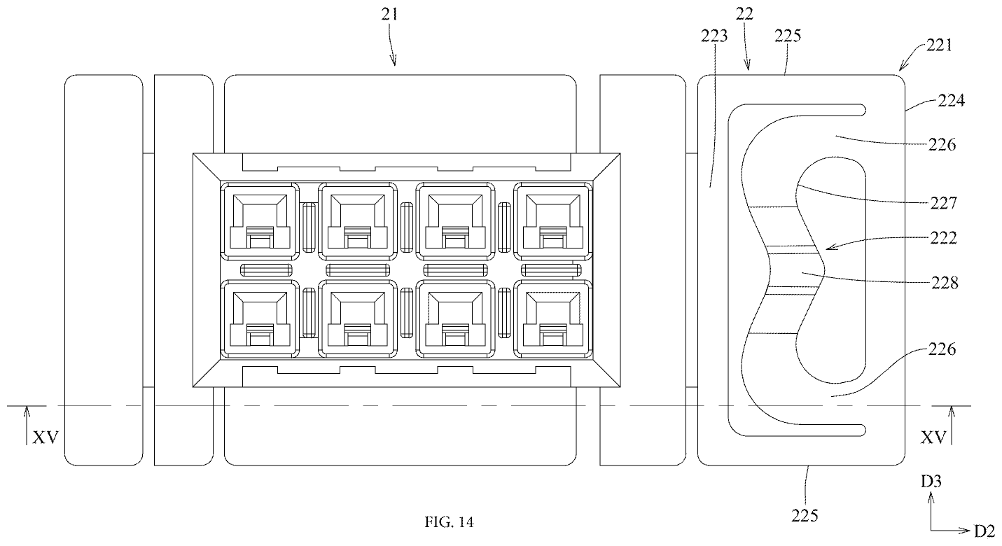

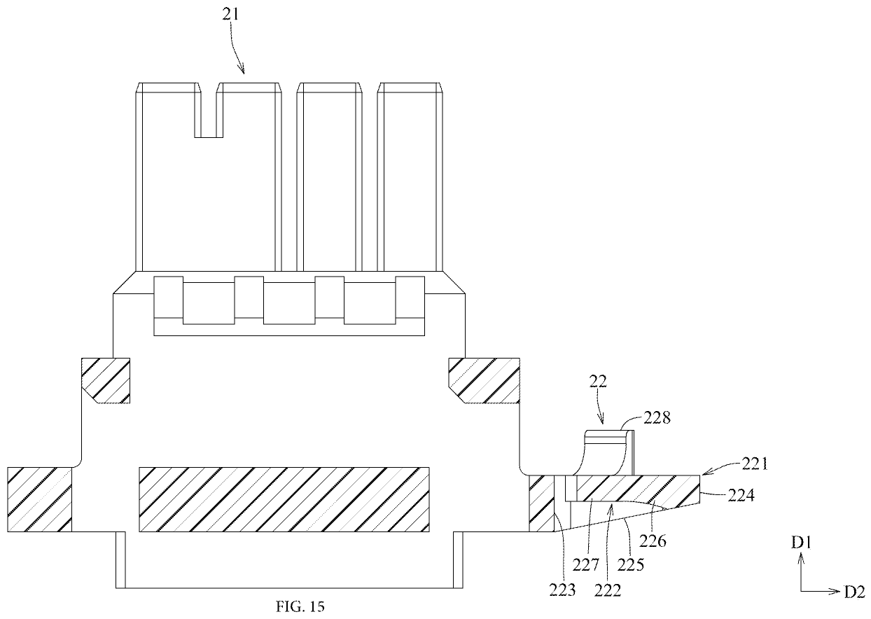

Referring to FIG. 12, FIG. 13, FIG. 14 and FIG. 15, a thickness of each side frame body 225 of the protecting frame 221 of the locking member 22 taken along the first direction D1 tapers from the inner frame body 223 toward the outer frame body 224. Therefore, the elasticity of each side frame body 225 can be increased, so that the elasticity of each side frame body 225 of the second embodiment is better than the elasticity of each side frame body 225 of the first embodiment.

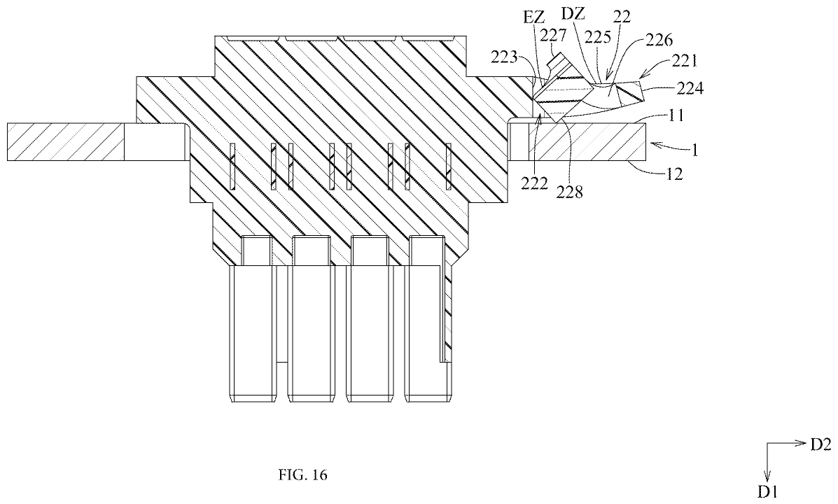

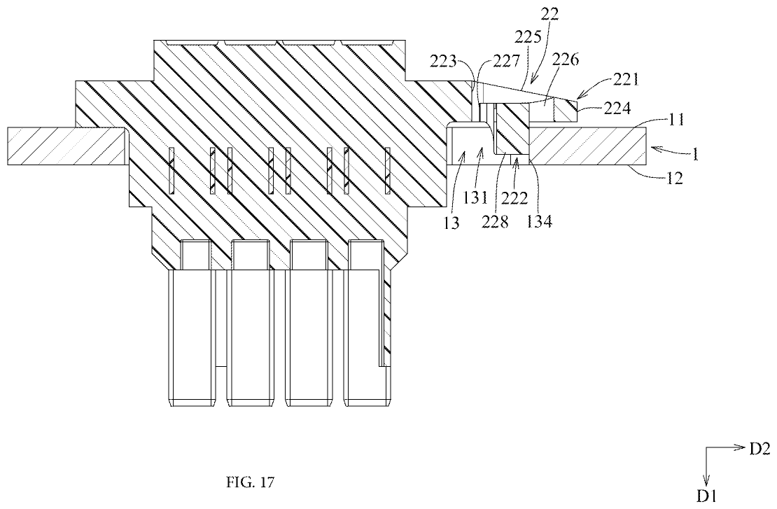

Referring to FIG. 16 and FIG. 17, because each side frame body 225 has better elasticity, when the insulative housing 21 is in the inserting position, an extent of bend deformation of the deformable zone DZ constructed by the side frame bodies 225 is larger than the extent of bend deformation of the deformable zone DZ of the first embodiment. Therefore, velocity and smoothness of deformation of the locking member 22 can be further promoted when the lock protruding portion 228 is squeezed by the panel 1 or the lock protruding portion 228 is separated from the panel land is not squeezed by the panel 1.

Referring to FIG. 11, FIG. 12 and FIG. 13, a structure of the plug electrical connection device 120 is similar to a structure of the receptacle electrical connection device 110. The plug electrical connection device 120 includes a panel 5 and a connector 6. The panel 5 includes a first panel surface 51 which is toward the front and a second panel surface 52 which is toward the rear and is opposite to the first panel surface 51. The panel 5 is formed with an opened hole 53 which extends between the first panel surface 51 and the second panel surface 52. The opened hole 53 has a long hole portion 531 and two pairs of aligning hole portions 532 communicated with the long hole portion 531. A length direction of the long hole portion 531 extends along the second direction D2. The long hole portion 531 is defined together by two long inner sides 533 of the panel 5 which are spaced apart from each other along the third direction D3 and two short inner sides 534 of the panel 5 which are spaced apart from each other along the second direction D2. Each pair of aligning hole portions 532 respectively extend upwardly and downwardly from the two long inner sides 533 and are adjacent to the corresponding short inner side 534.

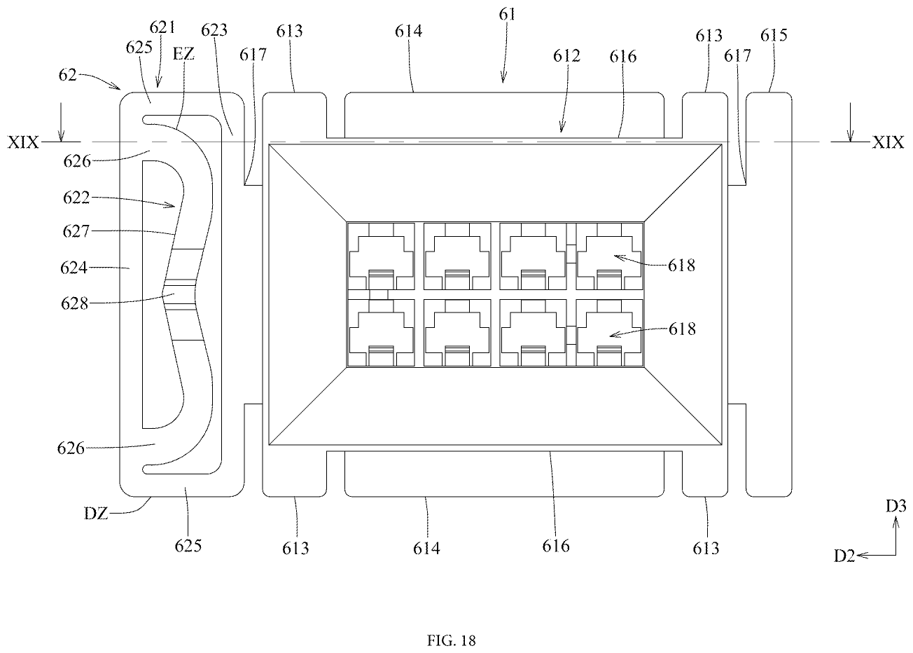

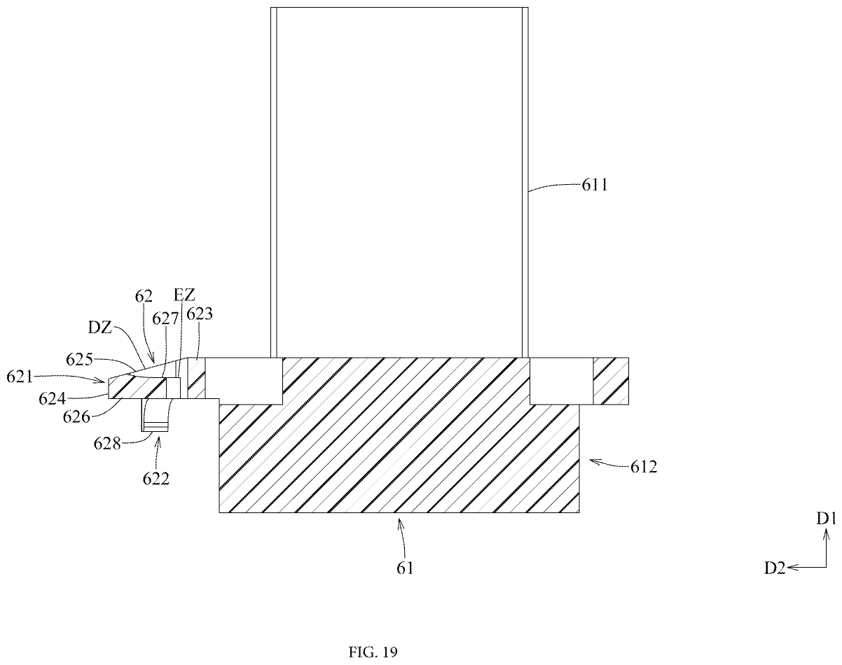

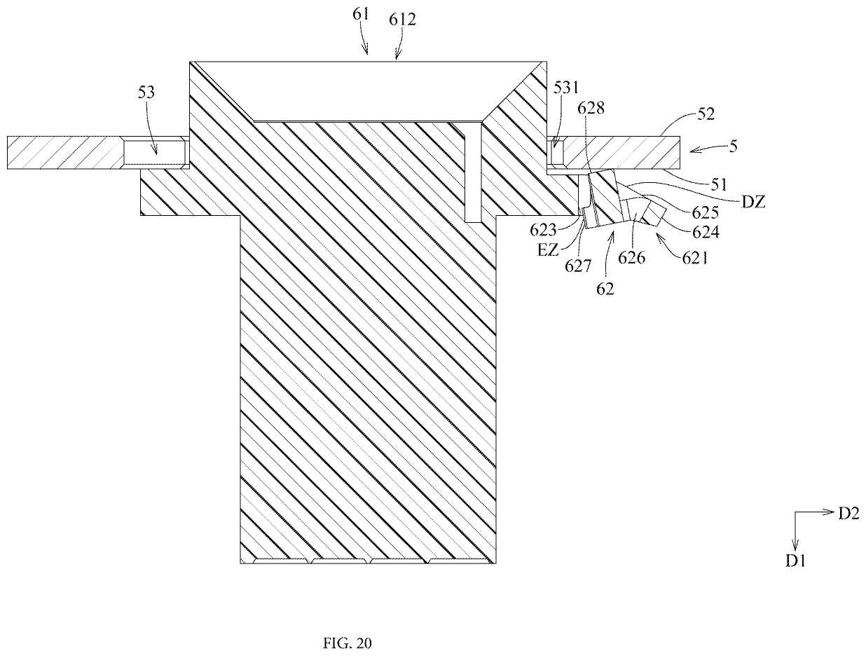

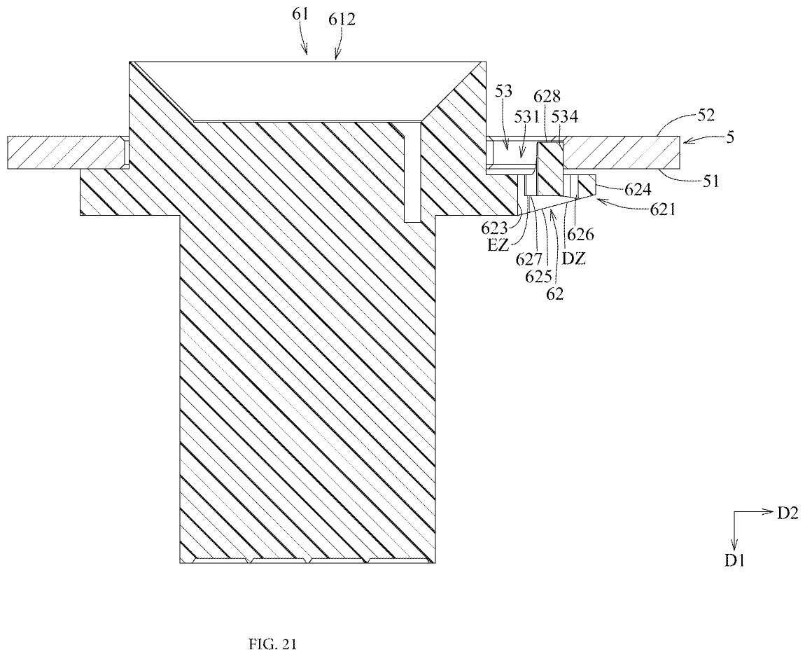

Referring to FIG. 12, FIG. 13, FIG. 18 and FIG. 19, the connector 6 is a plug connector and includes an insulative housing 61, a locking member 62 and a plurality of terminals 63. The insulative housing 61 is configured to be capable of moving relative to the panel 5 along the first direction D1 to an inserting position (as shown in FIG. 20) where the insulative housing 61 inserts into the opened hole 53 from the first panel surface 51, and be capable of moving from the inserting position to an assembled position (as shown in FIG. 21) along the second direction D2. The insulative housing 61 has a body portion 611, a mating portion 612, two pairs of alignment protruding blocks 613, a pair of first abutment protruding blocks 614, and a second abutment protruding block 615. The mating portion 612 is formed to a rear end of the body portion 611 and is in form of elongated shell shape. The mating portion 612 has two long sides 616 which are spaced apart from each other along the third direction D3 and two short sides 617 which are spaced apart from each other along the second direction D2. The mating portion 612 is used to insert into the long hole portion 531 of the opened hole 53 and is capable of partially extending out of the second panel surface 52. The mating portion 612 is capable of moving in the long hole portion 531 along the second direction D2. The mating portion 612 and the body portion 611 together define a plurality of terminal slots 618 which are arranged and are spaced apart from each other and are used to respectively allow the plurality of terminals 63 to be received therein.

Each pair of alignment protruding blocks 613 respectively extend upwardly and downwardly from the two long sides 616 of the mating portion 612, are adjacent to the corresponding short side 617 and are away from the body portion 611. Each alignment protruding block 613 is used to insert into the corresponding aligning hole portion 532 of the opened hole 53. By an alignment mechanism provided by cooperation of the alignment protruding block 613 and the corresponding aligning hole portion 532, the insulative housing 61 indeed can be guided to move to the inserting position. When the insulative housing 61 is in the inserting position, each alignment protruding block 613 passes through the corresponding aligning hole portion 532 and extends out of the second panel surface 52. When the insulative housing 61 is in the assembled position, each alignment protruding block 613 stops the second panel surface 52.

The pair of first abutment protruding blocks 614 respectively extend upwardly and downwardly from the two long sides 616 of the mating portion 612. Each first abutment protruding block 614 is adjacent to the body portion 611, and is positioned in front of the corresponding alignment protruding block 613 along the first direction D1, and is spaced apart from the corresponding alignment protruding block 613 by a certain distance. Each first abutment protruding block 614 is used to abut the first panel surface 51 of the panel 5 so as to limit a depth that the mating portion 612 inserts into the long hole portion 531. The second abutment protruding block 615 is connected to one of the two short sides 617 of the mating portion 612, is used to abut the first panel surface 51 so as to limit the depth that the mating portion 612 inserts into the long hole portion 531. When the insulative housing 61 is in the inserting position or the assembled position, each first abutment protruding block 614 and the second abutment protruding block 615 all abut the first panel surface 51.

The locking member 62 has a protecting frame 621 and a locking arm 622 positioned in the protecting frame 621. The protecting frame 621 has an inner frame body 623 which is connected to the other of the two short sides 617 of the insulative housing 61, an outer frame body 624 which is spaced apart from the inner frame body 623 along the second direction D2 and is positioned at an outer side of the inner frame body 623, and two side frame bodies 625 which are connected between the inner frame body 623 and the outer frame body 624 and are spaced apart from each other along the third direction D3. In the second embodiment, that the second abutment protruding block 615 is connected the short side 617 which is positioned at the right is taken as example, and that the inner frame body 623 is connected to the short side 617 which is positioned at the left is taken as example.

The locking arm 622 has two end portions 626, an elastic arm portion 627 which is connected between the two end portions 626, and a lock protruding portion 628 which is connected to a rear end surface of the elastic arm portion 627. The elastic arm portion 627 constructed as an elastic zone EZ which is bendable. The two end portions 626 are connected to an inner side of the outer frame body 624, so as to make the two side frame bodies 625 of the protecting frame 621 constructed as a deformable zone DZ which is bendable. That the two end portions 626 of the second embodiment are integrally connected to the outer frame body 624 is taken as example. The lock protruding portion 628 protrudes from a rear end surface of the protecting frame 621, is used to contact the first panel surface 51 of the panel 5, and is used to insert into the long hole portion 531 of the opened hole 53 so as to be locked to the corresponding short inner side 534. When the lock protruding portion 628 is squeezed by the first panel surface 51 of the panel 5, the elastic zone EZ and the deformable zone DZ all are capable of bending deformation. When the insulative housing 61 positioned in the assembled position, the lock protruding portion 628 inserts into the long hole portion 531 so as to be locked to the corresponding short inner side 534.

In the second embodiment, a thickness of each side frame body 625 taken along the first direction D1 tapers from the inner frame body 623 toward the outer frame body 624. Therefore, the elasticity of each side frame body 625 can be increased. The elastic arm portion 627 of the locking arm 622 is in form of M-shape, the elastic arm portion 627 has a length interposed between the two end portions 626. Therefore, the elastic arm portion 627 can have a longer length and a better elasticity under restriction of a limited space of the protecting frame 621. The elastic arm portion 627 has a pointed convex segment 629 which convexly extends toward the outer frame body 624, the lock protruding portion 628 protrudes from a rear end surface of the pointed convex segment 629. Therefore, when the lock protruding portion 628 is squeezed by the first panel surface 51 to be subjected to a force, the lock protruding portion 628 is capable of uniformly dispersing the force upwardly and downwardly to the elastic arm portion 627. A thickness of the elastic arm portion 627 taken along the first direction D1 is less than a thickness of each end portion 626 taken along the first direction D1, a width of the elastic arm portion 627 is less than a width of each end portion 626. Therefore, the elasticity of the elastic arm portion 627 can be further increased, and a connecting strength between each end portion 626 and the inner side of the outer frame body 624 can be increased.

Each terminal 63 is a male terminal which is received in the corresponding terminal slot 618, each terminal 63 is used to insert into the corresponding terminal 23 and is electrically connected with the corresponding terminal 23.

Referring to FIG. 12, FIG. 13 and FIG. 20, when the insulative housing 61 is to be assembled to the panel 5, firstly, the mating portion 612 is aligned with the long hole portion 531 of the opened hole 53, and each alignment protruding block 613 is aligned with the corresponding aligning hole portion 532 of the opened hole 53. Next, the insulative housing 61 is moved rearwardly toward the first panel surface 51 of the panel 5 along the first direction D1. A part of the mating portion 612 will insert into the long hole portion 531 and extends out of the second panel surface 52, each alignment protruding block 613 will insert into the corresponding aligning hole portion 532 of the opened hole 53 and then pass through the corresponding aligning hole portion 532 and extend out of the second panel surface 52. Then, the lock protruding portion 628 of the locking member 62 will contact the first panel surface 51 of the panel 5 and is squeezed by the first panel surface 51. A squeezing force applied to the lock protruding portion 628 by the first panel surface 51 will make the lock protruding portion 628 bring the elastic arm portion 627 to rotate relative to the two end portions 626, which makes the elastic arm portion 627 bent and deformed and accumulate a restoring elastic force. The squeezing force will be further transferred to the two side frame bodies 625 via the two end portions 626 and the outer frame body 624, which makes the two side frame bodies 625 bent and deformed and accumulate a restoring elastic force.

When two first abutment protruding blocks 614 and the second abutment protruding block 615 abut the first panel surface 51 of the panel 5, the insulative housing 61 cannot further move rearwardly and thus is positioned in the inserting position.

Referring to FIG. 11, FIG. 12 and FIG. 21, the insulative housing 61 is pushed rightwardly along the second direction D2, so that the insulative housing 61 is moved rightwardly from the inserting position. In a process that the insulative housing 61 is moved rightwardly, each alignment protruding block 613 leaves the corresponding aligning hole portion 532 and moves to behind the second panel surface 52, but the lock protruding portion 628 will move rightwardly relative to the first panel surface 51 in a state that the lock protruding portion 628 abuts the first panel surface 51 with applying an elastic force to the first panel surface 51.

When the insulative housing 61 moves to the assembled position as shown in FIG. 21, the restoring elastic force accumulated by the elastic arm portion 627 brings the lock protruding portion 628 to rotate and restore, and the restoring elastic force accumulated by the two side frame bodies 625 brings the outer frame body 624 and the locking arm 622 to rotate and restore, so the lock protruding portion 628 is capable of automatically inserting into the long hole portion 531 and being locked to the corresponding short inner side 534. By that the lock protruding portion 628 is locked to the corresponding short inner side 534, it can prevent the insulative housing 621 from shaking along the second direction D2. By that the pair of alignment protruding blocks 613 stop the second panel surface 52 and the two first abutment protruding blocks 614 and the second abutment protruding block 615 abut the first panel surface 51, it can prevent the insulative housing 61 from shaking along the first direction D1. Therefore, the insulative housing 61 can be firmly positioned in the assembled position.

By that the protecting frame 621 is a frame which encircles an outer periphery of the locking arm 622, the protecting frame 621 can function as protecting the outer periphery of the locking arm 622, so as to avoid the locking arm 622 being subjected to improper external force hit and being damaged. Moreover, by that the elastic arm portion 627 is connected between the two end portions 626 to construct the elastic zone EZ which is bendable, and the two end portions 626 are connected to the inner side of the outer frame body 624 so that the two side frame bodies 625 are constructed as the deformable zone DZ which is bendable, the locking member 62 has better elasticity. Therefore, velocity and smoothness of deformation of the locking member 62 can be promoted when the lock protruding portion 628 is squeezed by the panel 5 or the lock protruding portion 628 is separated from the panel 5 and is not squeezed by the panel 5.

It is noted that, the plug electrical connection device 120 of the second embodiment also may have the following implementing manners as desired.

One implement manner is the number of the aligning hole portion 532 of the panel 5 and the number of the alignment protruding block 613 of the insulative housing 61 each are one.

Another implement manner is the number of the first abutment protruding block 614 of the insulative housing 61 is one and the second abutment protruding block 615 is omitted.

Still another implement manner is, the insulative housing 61 only has the second abutment protruding block 615 and the first abutment protruding blocks 614 is omitted.

In conclusion, with respect to the receptacle electrical connection device 110 of each embodiment and the plug electrical connection device 120 of the second embodiment, by that the protecting frame 221, 621 is a frame which encircles the outer periphery of the locking arm 222, 622, the protecting frame 221, 621 can function as protecting the outer periphery of the locking arm 222, 622, so as to avoid the locking arm 222, 622 being subjected to improper external force hit and being damaged. By that the elastic arm portion 227, 627 is connected between the two end portions 226, 626 to construct the clastic zone EZ which is bendable, and the two end portions 226, 626 are connected to the inner side of the outer frame body 224, 624 so that the two side frame bodies 225, 625 are constructed as the deformable zone DZ which is bendable, the locking member 22, 62 has better elasticity. Therefore, velocity and smoothness of deformation of the locking member 22, 62 can be promoted when the lock protruding portion 228, 628 is squeezed by the panel 1, 5 or is separated from the panel 1, 5 and is not squeezed by the panel 1, 5. Moreover, with respect to the plug electrical connection device 120 of the first embodiment, by that the protrusion 433 extends from the extending suspending segment 432 toward the circuit board 3, the extending suspending segment 432 will not contact the circuit board 3 and even will not approach the circuit board 3. Therefore, it can avoid solder wicking phenomenon occurring and in turn resulting in short circuit between the plurality of terminals 42 when the plurality of tail segments 422 are soldered to the plurality of soldering holes 31, so the objects of the present disclosure can be indeed achieved.

However, the above description is only for the embodiments of the present disclosure, and it is not intended to limit the implementing scope of the present disclosure, and the simple equivalent changes and modifications made according to the claims and the contents of the specification are still included in the scope of the present disclosure.

What is claimed is:

1. An electrical connection device, comprising:
a panel formed with an opened hole;
a connector comprising:
an insulative housing configured to be capable of inserting into the opened hole of the panel and moving in the opened hole to an assembled position; and
a locking member having a protecting frame and a locking arm positioned in the protecting frame, the protecting frame having an inner frame body which is connected to the insulative housing, an outer frame body, and two side frame bodies which connect the inner frame body and the outer frame body, the locking arm having two end portions, an elastic arm portion which is connected between the two the end portions, and a lock protruding portion which is connected to the elastic arm portion, the elastic arm portion being constructed as an elastic zone which is bendable, the two end portions being connected to an inner side of the outer frame body so that the two side frame bodies of the protecting frame being constructed as a deformable zone which is bendable, when the lock protruding portion is squeezed by the panel, the elastic zone and the deformable zone all being capable of bending deformation, when the insulative housing is positioned in the assembled position, the lock protruding portion inserting into the opened hole and being locked to the panel.

2. The electrical connection device of claim 1, wherein
a thickness of the elastic arm portion is less than a thickness of each end portion.

3. The electrical connection device of claim 1, wherein
a width of the elastic arm portion is less than a width of each end portion.

4. The electrical connection device of claim 2, wherein
a width of the elastic arm portion is less than a width of each end portion.

5. The electrical connection device of claim 1, wherein
a thickness of each side frame body tapers from the inner frame body toward the outer frame body.

6. The electrical connection device of claim 1, wherein
the elastic arm portion of the locking arm is in form of M-shape and has a pointed convex segment which convexly extends toward the outer frame body, the lock protruding portion protrudes from the pointed convex segment.

7. The electrical connection device of claim 1, wherein
the insulative housing has a mating portion, the connector further comprises a plurality of terminals provided to the mating portion.

8. The electrical connection device of claim 1, wherein
the insulative housing is configured to be capable of moving relative to the panel along a first direction to an inserting position where the insulative housing inserts into the opened hole, and is capable of moving from the inserting position to the assembled position along a second direction perpendicular to the first direction.

9. The electrical connection device of claim 8, wherein
the panel comprises a first panel surface and a second panel surface which are opposite to each other, the opened hole extends between the first panel surface and the second panel surface and has an aligning hole portion,
the insulative housing is capable of inserting into the opened hole from the first panel surface along the first direction, the insulative housing has an alignment protruding block and an abutment protruding block which is spaced apart from the alignment protruding block along the first direction,
when the insulative housing is in the inserting position, the alignment protruding block passes through the aligning hole portion and extends out of the second panel surface, the abutment protruding block abuts the first panel surface,
when the insulative housing is in the assembled position, the alignment protruding block stops the second panel surface, the abutment protruding block abuts the first panel surface.

10. The electrical connection device of claim 1, wherein
the connector is a receptacle connector.

11. The electrical connection device of claim 1, wherein
the connector is a plug connector.

12. An electrical connection device comprising:
a circuit board; and
a plug connector erectly provided to the circuit board and comprising an insulative housing, a plurality of terminals provided to the insulative housing, and a spacing plate, each terminal having a tail segment electrically connected to the circuit board, the spacing plate having a retaining segment which is retained in the insulative housing, an extending suspending segment which extends out of the insulative housing, and a protrusion which extends from the extending suspending segment toward the circuit board, the extending suspending segment and the circuit board being therebetween formed with a gap, the extending suspending segment being formed with a plurality of penetrating holes which respectively allow the plurality of the tail segments of the plurality of the terminals to insert therein.

13. The electrical connection device of claim 12, wherein
the protrusion is positioned in the middle of the plurality of the penetrating holes.

14. The electrical connection device of claim 12, wherein
the plurality of the penetrating holes are arranged as columns along a first direction and are arranged as rows along a second direction perpendicular to the first direction, the number of the columns and the number of the rows each are even,
the protrusion is positioned in the middle of the columns in the first direction and is positioned in the middle of the rows in the second direction.

15. The electrical connection device of claim 12, wherein
the protrusion is adjacent to the circuit board and does not contact the circuit board.

16. The electrical connection device of claim 12, wherein
the protrusion abuts the circuit board.

17. The electrical connection device of claim 12, wherein
the insulative housing has a bottom portion and at least one positioning post which extends downwardly from the bottom portion,
the retaining segment is formed with at least one positioning hole which interference fits with the positioning post.

18. The electrical connection device of claim 17, wherein
the insulative housing has two positioning posts which are spaced apart from each other,
the retaining segment is formed with two positioning holes which respectively interference fit with the two positioning posts.

19. The electrical connection device of claim 12, wherein
the insulative housing has a bottom portion and two wall portions which extend downwardly from the bottom portion and are respectively adjacent to two opposite sides of the bottom portion,
each wall portion is formed with a snapping groove,
the retaining segment has two side edge portions which respectively snap to the two snapping grooves of the two wall portions.

20. An electrical connection device assembly comprising:
the electrical connection device of claim 1, the electrical connection device being a receptacle electrical connection device, the connector being a receptacle connector; and
a plug electrical connection device which is used to mate with the receptacle connector of the receptacle electrical connection device.
